(19) United States
(12) Patent Application Publication
(10) Pub. No.: US 2003/0105926 A1
(43) Pub. Date: Jun. 5, 2003

(54) Variable size prefetch cache

(75) Inventor: Jorge R. Rodriguez, Cary, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machies Corporation, Armonk, NY

(21) Appl. No.: 10/008,449

(22) Filed: Dec. 3, 2001

(51) Int. Cl. G06F 12/00

(52) U.S. Cl. 711/129; 711/137

(57) ABSTRACT

A partition cache has variable size prefetch cache and main cache partitions. The cache size management algorithm adapts automatically to the requirements of the sequential content in the I/O request stream. When longer prefetch packets are used and/or larger number of sequential runs are detected the prefetch cache is made larger by the cache manager. Otherwise, when the size requirements for the prefetch cache are reduced, the main cache size is made larger.

### TECHNICAL FIELD OF THE INVENTION

The present invention relates in general to data processing systems, and in particular, to a system for prefetching data from memory.

### BACKGROUND OF THE INVENTION

A network server, e.g., file server, database server, web server, maybe configured to receive a stream of requests from clients in a network system to read from or write to a disk, e.g., disk drive, in the network server. These requests may form what is commonly referred to as a “workload” for the network server. That is, a workload may refer to the requests that need to be serviced by the network server.

Typically, a server in a network system comprises a disk adapter that bridges the disk, e.g., disk drive, to the processing unit of the server unit. A server may further comprise a cache commonly referred to as a disk cache within the disk adapter to increase the speed of accessing data. A cache is faster than a disk and thereby allows data to be read at higher speeds. Thus, if data is stored in the cache it may be accessed at higher speeds than accessing the data on the disk.

There have been many methods in designing disk caches that seek to increase the cache hit rate thereby improving performance of the disk cache. A “cache hit” is said to occur if an item, e.g., data, requested by the processor in the server or a client in a network system, is present in the disk cache. When an item, e.g., data, requested by the processor in the server or a client in the network system, is not present in the cache, a “cache miss” is said to occur. A “cache hit rate” may refer to the rate at which cache hits occur. By improving the cache hit rate, the performance of the cache may be improved, i.e., less data needs to be serviced from the disk. Prefetching algorithms are often employed to improve such cache hit rates.

A chronic problem with prefetching techniques is that the cache can be flooded with unproductive prefetched blocks. Read lookahead operations can actually reduce the performance of the storage subsystem if the prefetched blocks are never referenced. To make the problem worse, prefetched blocks can replace cache blocks that would have otherwise been referenced had they remained resident in the cache.

### SUMMARY OF THE INVENTION

The present invention addresses the foregoing problems to avoid cache flooding by using a partitioned cache approach. The cache is partitioned into a main cache and a prefetch cache. The main cache is specialized to store non-sequential requests present in the I/O request stream, and the prefetch cache is specialized to store sequential requests in the I/O request stream. Because of the interface design between the main cache and the prefetch cache, prefetched data does not flow through the main cache, therefore flooding of the main cache with prefetched data is prevented. A prefetch algorithm is described that has the ability to detect the beginning of a sequential stream interleaved within the I/O request stream. This stream can be detected from blocks resident in either the main cache, or the prefetch cache. If the block is resident in the main cache when it is detected that it is associated with the beginning of a sequential stream, this generates a prefetch action, and the block referenced, as well as the prefetched data, are moved to the prefetch cache. Once prefetch data resides in the prefetch cache, the algorithm keeps prefetching blocks as long as there are references in the I/O request stream that are serviced from the prefetch data in the cache.

The storage requirement in the cache for the various sequential streams in the I/O request stream change over time, according to the run length of a particular sequential stream, and to the number of sequential streams in the I/O request stream. The present invention addresses this by implementing a variable cache structure and algorithm that is optimized to the sequential streams present in the I/O request stream. The size of the cache changes automatically and adaptively according to the requirements of the I/O request stream. This is implemented with a partitioned cache having a variable size prefetch cache and main cache partitions. The cache size management algorithm adapts automatically to the requirements of the sequential content in the I/O request stream. When longer prefetch packets are used and/or larger number of sequential runs are detected, the prefetch cache is made larger by the cache manager. Otherwise, when the size requirements for the prefetch cache are reduced, the main cache size is made larger. More specifically, the prefetch cache contains variable size structures to support the adaptive prefetch algorithm. A multi-block structure of variable size called a superblock receives the prefetched packet of size N. As the prefetch data in the superblock is spent, the spent blocks are evicted from the cache. The superblock size thus is largest when the prefetched blocks are received and gets smaller as the blocks are spent.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a high level block diagram of the cache management structure of the present invention;

FIG. 2 illustrates various aspects of the algorithm in accordance with the present invention;

FIG. 3 illustrates a variable size prefetch cache in accordance with the present invention;

FIG. 4 illustrates a data processing system configured in accordance with the present invention;

FIG. 5 illustrates multiple independent sequential request streams; and

FIG. 6 illustrates a fixed size prefetch cache in accordance with the present invention.

### DETAILED DESCRIPTION

In the following description, numerous specific details are set forth such as specific word, byte, or block lengths, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

Two properties of an I/O request stream from a processor to a disk array that can be exploited to improve system performance are temporal locality and spacial locality. Temporal locality means that if a given disk location is fetched, there is a higher probability that it will be fetched again early in the reference stream rather than later. With temporal locality, the same location is requested two or more times. Spacial locality means that if a given disk location is fetched, there is a higher probability that locations with an address that are successors (or predecessors) close to it will also be fetched, rather than one that is distant. Spacial locality is exhibited by workloads that are sequential in nature. With spacial locality, the same location is not requested more than one time. Non-sequential workloads can exhibit temporal locality but no spacial locality. Workloads that are random can exhibit temporal locality but not spacial locality. The present invention describes techniques that exploit spacial locality, such as data read lookahead (prefetched). Techniques that exploit temporal locality are addressed in this invention in ways that relate to the data prefetch and the two are said to be integrated. It is assumed that a cache is designed according to this invention to take advantage of both temporal and spacial locality.

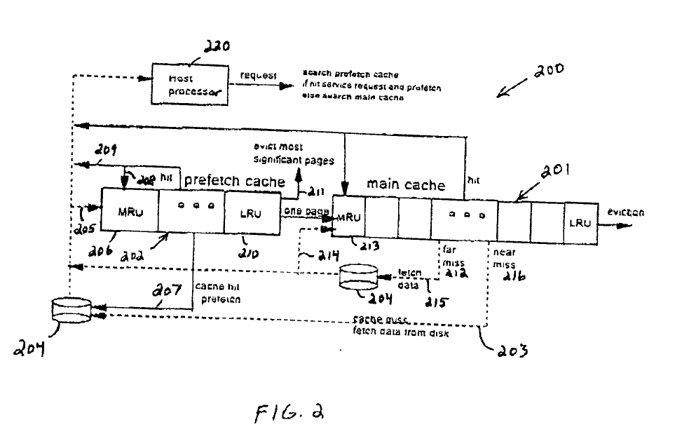

To solve the problem of cache flooding, the cache is partitioned into two separate cache partitions as illustrated in FIG. 2. The data cache 200 is partitioned into the main cache 201, designated for random and non-sequential entries, and the prefetch cache 202, designated for sequential entries.

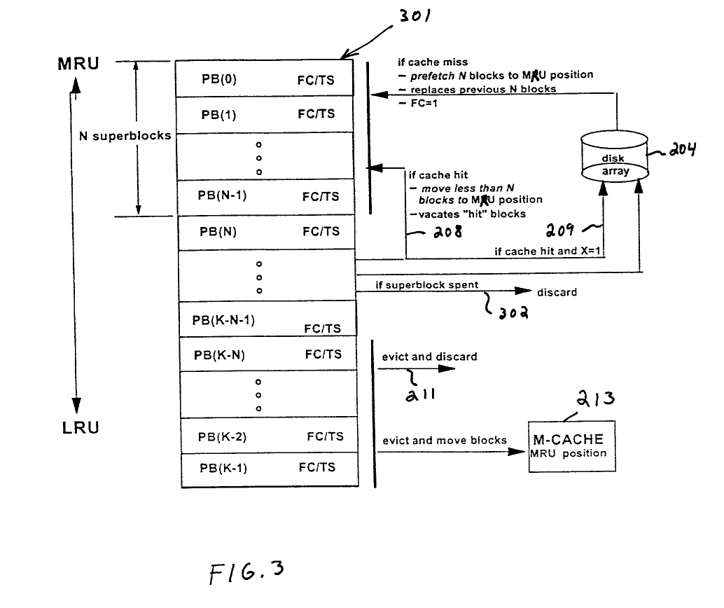

Referring to FIGS. 2 and 3, the prefetch cache 202 is organized as a least recently used (LRU) stack. The block size for the prefetch cache 202 is made the same as the block size for the main cache 201, and a new cache data structure, the superblock 301 (PB(i)), is defined to be of a variable size with a maximum size the same as the prefetch size (N pages). The unit of data transfer in the main cache 201 is the cache block. The unit of transfer of data in the prefetch cache 202 is the superblock 301: data is transferred in blocks of N blocks (1 superblock). The base entry (p⁰) in the superblock 301 contains the data originally requested in the I/O request stream. The rest of the entries (p¹ . . . p^{N-1}) in the superblock 301 contain the additional data that was fetched as part of the data prefetch request. Base entry information is marked in the directory because the base entry can be the subject of special actions by the cache manager.

Within the prefetch cache 202, the superblock 301 is the basic unit for the movement of data. Prefetch brings in a packet of N blocks, the size of the superblock. Evictions out of the prefetch cache 202 take place in superblock chunks. A cache hit to one or more blocks inside a cache superblock causes the entire superblock to be moved to the prefetch cache MRU position 213.

The cache replacement algorithm for either the prefetch cache 202 or the main cache 201 is not defined for the purposes of this invention, except for certain requirements as described below. The cache replacement algorithm for the prefetch cache 202 may use an LRU replacement policy, such as discussed within “Evaluation Techniques for Storage Hierarchy,” J. Gecsei, D R. Slutz, and I. L. Traiger, IBM System Journal, No. 2, 1970, pp. 78-117, which is hereby incorporated by reference herein. A frequency count (FC) counter and a time stamp (TS) are kept in the directory for each entry, as required by the LRU and LFU techniques. FC and TS are information that is used by the cache algorithm Additional extensions and modifications required by the invention for the cache replacement algorithm are defined below.

The size of the prefetch packet is variable and adapts to the workload. There are two factors that affect the maximum size of the prefetch. The first is the maximum size of the superblock. This size is specified to the program in a register. The maximum size of the superblock depends on the maximum size of the prefetch cache and the maximum number of sequential streams supported. Note that in practical cases, this is not a limitation to the prefetch algorithm. A second determining factor is that the cache manager makes a prediction about the size of the sequential stream run length, then sizes the prefetch packet according to the prediction. The prediction algorithm can be any described in the prior art.

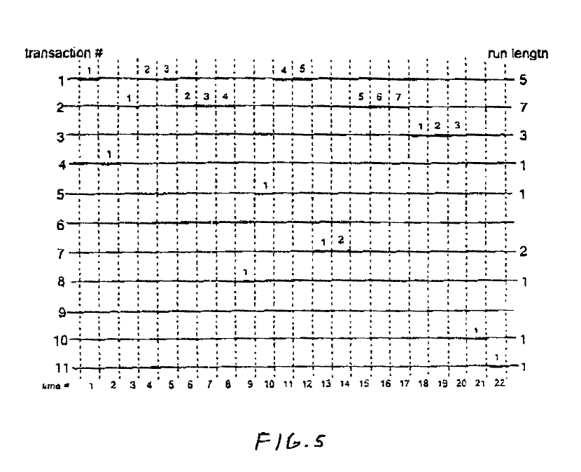

The method described by the present invention supports a variable number of concurrent sequential I/O request streams as targets for prefetching. There can be multiple independent sequential streams superimposed on the same I/O request stream, as illustrated in FIG. 5. In other words, sequential streams do not occur serially and atomically (in one complete uninterrupted segment) in the I/O request stream. Instead, these are interleaved and intermixed. This is important for the detection of a sequential stream, because there are “parallel detectors” for this purpose. FIG. 5 shows how this will look on a timeline. Along the horizontal axis, time intervals 1 through 22 are shown. Along the vertical axis, 11 sequential streams or random requests are shown. These are the elements of the I/O request stream at times 1, 2, and 22. It can be seen that at time 1, there is one block from stream 1 in the I/O request stream. At time 2, there is a (possible) random request 4, at time 3, block and form stream 2. At times 4 and 5, blocks 2 and 3 form stream 1. At times 6, 7, and 8, blocks 2, 3 and 4 form stream 2. And so on. The I/O requests from each stream normally do not occur in consecutive positions in the request stream, but are interleaved with the entries from other sequential streams. These multiple streams need to be detected and the individual requests stored in a different buffer entry.

When the data is not found in the main cache 201 (a cache miss) and the address of the requested data is more distant than a predetermined N position from all the entries in the prefetch cache 202 (including the main cache 201), then this is defined as a cache Far Miss 212. Far Misses 212 involve blocks that are not part of a sequential stream. A Far Miss 212 in main cache 201 generates a request (fetch) 215 to the disk array 204 with no prefetch and is brought 214 into the MRU (most recently used position) 213 of the main cache 201.

When the data is not found in the main cache 201 (a cache miss), and an entry is found in the cache whose address is next to the address of the requested data (successor N entries or predecessor N entries, where N is predetermined), then this is defined as a cache near miss 216. A near miss 216 is often used to detect the beginning of a sequential stream. A near miss 216 in the main cache 201 generates a request 203 to the disk array 204 with a prefetch of N entries. The returning data is placed 205 into the prefetch cache MRU position 206.

Once the beginning of a sequential stream has been detected with a near miss 216 and the data brought into the prefetch cache 202, prefetching 207 continues during cache hits. Prefetching 207 occurs when the last block (p^{N-1}) of the superblock 301 is hit. As an alternate implementation, there is an entry in the cache directory that specifies which block within the superblock 301 generates the prefetch when hit. That way a prefetch can begin earlier, thus creating more overlap with a request stream.

In the prefetch cache 202, super blocks 301 that get a hit to one or more blocks are moved 208 to the prefetch cache MRU position 206, but the block that received the hit is discarded 209. That means that the size of the superblock is reduced in size by repeated bits. Also, that means that superblocks that have been referenced least frequently are allowed to flow to the LFU position, where the LRU entry 210 is evicted 211 from the prefetch cache 202. In case of a tie, the superblock 301 with the least number of frequency counts (FC) is evicted out of the prefetch cache LRU position 210.

If all the blocks in a superblock have received hits, then all of the prefetched entries have been read by the host processor 220 and are less likely to be referenced again, and that superblock is considered to be spent 302. The reason for this is that the probability of a data entry receiving multiple references in a sequential stream is small. A superblock that has been spent 302 completely is no longer in the cache 200 because it has been evicted from the cache 200 gradually as blocks are evicted with every hit.

When a block gets a hit in the prefetch cache 202, the data in that entry is sent to the requesting process in the host processor 220, and the superblock (N blocks) is moved to the MRU position 206 in the prefetch cache 202.

Prefetching ends when the block within the superblock specified to start the next prefetch does not get a hit. Not getting a hit indicates the end of a sequential run, at least within the time window available for the detection of sequentiality.

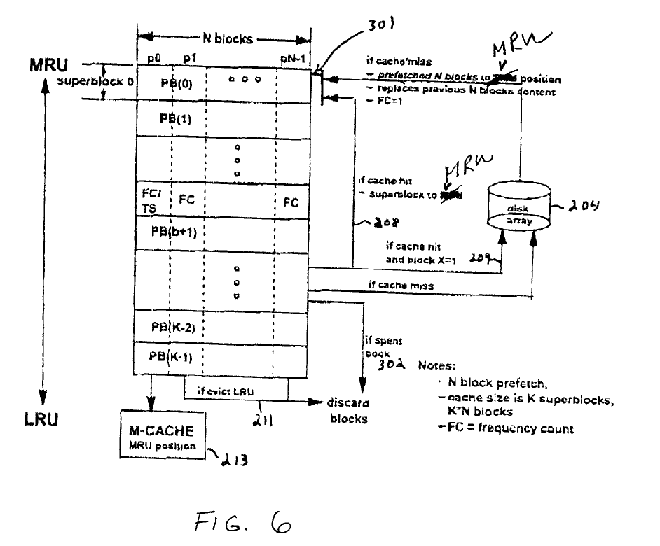

FIG. 6 illustrates another embodiment where the concepts of the present invention are implemented in a fixed size prefetch buffer which operates in a manner similar to the variable sized prefetch buffer of FIG. 3.

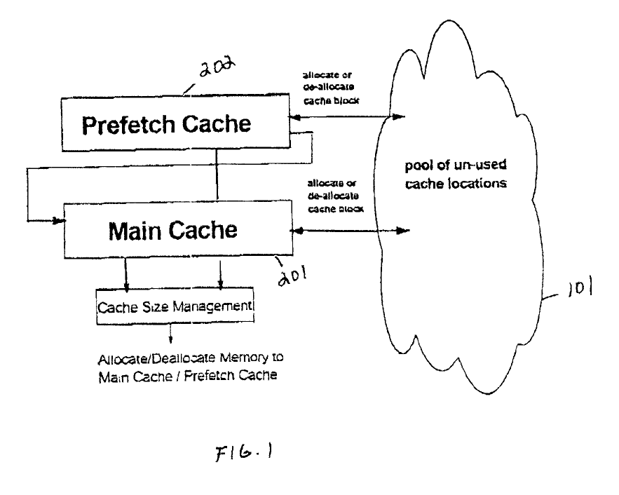

The partitioned cache 200 uses an adaptive method for cache reconfiguration and tuning to support a prefetch cache 202 whose size adapts to the characteristics of the request stream. The size of the prefetch packet is variable and adapts to the workload. There are two factors that affect the maximum size of the prefetch. First, the maximum size of the superblock is specified to the program in a register. The maximum size of the superblock depends on the maximum size of the prefetch cache 202 and the maximum number of sequential streams supported. Note that in practical cases this is not a limitation for the prefetch algorithm of the present invention. Secondly, the cache manager makes a prediction about the size of the sequential stream run length, then sizes the prefetch packet according to the prediction. The prediction algorithm can be any well-known process for predicting streams. The size of the prefetch cache 202 changes as multiple superblocks are brought into the cache as a prefetch package, and then they are reduced gradually to zero size as the prefetch algorithm executes. Depending on the demands of the request stream (on the amount of sequentiality), the size of the prefetch cache 202 varies relative to the size of the main cache 201. FIG. 1 illustrates a block diagram of the high level cache management structure of the present invention. A pool of unused cache locations 101 is kept to effect the allocation/deallocation of cache blocks to/from the prefetch cache 202 and the main cache 201. The number of unused cache locations contained in this pool 101 is typically zero. However, as the storage requirements of the prefetch cache 202 decreases, storage is returned to the pool 101, from where this storage is picked up from the main cache 201 when it needs additional blocks. If there is storage available in the pool 101, and a new block is brought into the main cache 201 after a cache miss, then instead of evicting the block in the LRU position, a new MRU position is added. On the other hand, if the prefetch cache 202 requirements for storage increases when the workload changes, then a demand is placed on the main cache 201 to evict the block in the LRU position and return the storage to the pool 101, from where it is picked up by the prefetch cache 202.

Normally, storage for N blocks of data are reserved in the pool 101 by the prefetch cache 202 every time a prefetch is initiated. If N blocks of storage are not available, then these must be serviced from the main cache 201 by evicting the required number of blocks. An estimate of the number of streams can be made. At a minimum, this number is the same as the number of sequential streams that are active in the prefetch operation. Then, between the locations in the prefetch cache 202 and in the pool 101, the total number of locations must add to Σᵢ₌₁^{k} nᵢ where k is the number of sequential streams working the prefetch cache 202 and nᵢ is the size for the n^{th} prefetch.

As the blocks of the superblock receives hits, those blocks are evicted from the cache and the associated storage is returned to the pool 101. This freed storage can be used for the next prefetch of the same sequential stream or for a new sequential stream. This way the partitioning of the cache is reconfigured according to the requirements of the I/O request stream.

The computation time overhead for cache management is small for a prefetch size of N because this cost will be distributed across the service time of N requests from the I/O request stream.

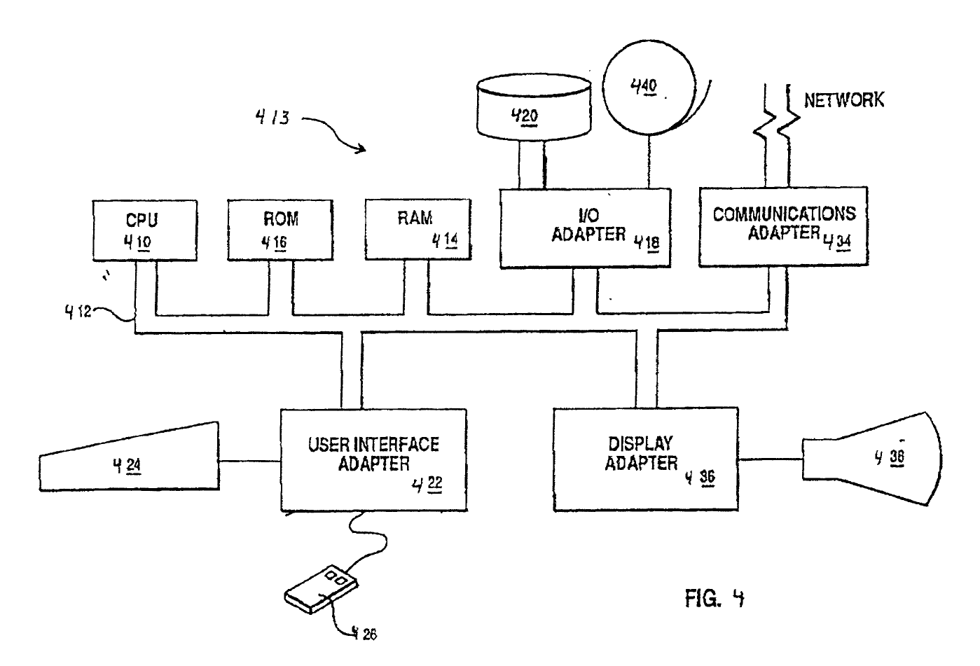

FIG. 4 illustrates an embodiment of the present invention of server 302. Referring to FIG. 4, one or more clients 301 may issue requests to read from or write to a disk 420 in server 302. It is noted that the embodiment of the present invention is not limited to read and/or write requests but any requests that require service from server 302. As stated in the Background Information section, these stream of requests may form what is commonly referred to as a workload. That is, a workload may refer to the requests that need to be serviced by server 302 In one embodiment, the workload may be managed by a disk adapter 418. If these requests in the workload may be serviced by a disk cache (not shown) within disk adapter 418 instead of disk 420, then the instructions and data requested may be accessed faster. Therefore, it is desirable to optimize the disk cache (not shown) so that as many requests may be serviced by the disk cache as possible. It is noted that a disk cache may reside in other locations than disk adapter 418, e.g., disk unit 420, application 450.

Referring to FIG. 4, server 302 may further comprise a central processing unit (CPU) 410 coupled to various other components by system bus 412. An operating system 440 runs on CPU 410 and provides control and coordinates the function of the various components of FIG. 4. Application 450, e.g., program for designing a cache, e.g., disk cache, configured to adaptively reconfigure, e.g., length of the stacks in the cache may adapt to changes in the request stream, as described in FIG. 5, runs in conjunction with operating system 440 which implements the various functions to be performed by application 450. Read only memory (ROM) 416 is coupled to system bus 412 and includes a basic input/output system (“BIOS”) that controls certain basic functions of server 302. Random access memory (RAM) 414, disk adapter 418 and communications adapter 434 are also coupled to system bus 412. It should be noted that software components including operating system 440 and application 450 are loaded into RAM 414 which is the computer system's main memory. Disk adapter 418 may be a small computer system interface (“SCSI”) adapter that communicates with disk units 420, e.g., disk drive. It is noted that the program of the present invention that designs a cache, e.g., disk cache, configured to adaptively reconfigure, e.g., length of the stacks in the cache may adapt to changes in the request stream, as described in FIG. 5 may reside in disk adapter 418, disk unit 420 or in application 450. Communications adapter 434 interconnects bus 412 with an outside network enabling server 302 to communicate with other such systems. Input/Output devices are also connected to system bus 412 via a user interface adapter 422 and a display adapter 436.

Although the present invention and its advantages have been described in detail, it should be understood that various changes, substitutions and alterations can be made herein without departing from the spirit and scope of the invention as defined by the appended claims.

What is claimed is:

1. A method for prefetching data into a cache associated with a processor, comprising the steps of:
partitioning the cache into a prefetch cache and a main cache, wherein the prefetch cache is configured to store sequential requests in an input/output (I/O) request stream, and wherein the main cache is configured to store non-sequential requests in the I/O request stream; and
varying a capacity of the prefetch cache as a function of a magnitude of one or more sequential streams in the I/O request stream.

2. The method as recited in claim 1, wherein the varying step further comprises the step of varying the capacity of the prefetch cache as a function of a run length of a particular sequential stream in the I/O request stream.

3. The method as recited in claim 2, wherein the capacity of the prefetch cache is increased when longer prefetch packets are requested in the I/O request stream.

4. The method as recited in claim 3, wherein a capacity of the main cache is decreased as the capacity of the prefetch cache is increased.

5. The method as recited in claim 2, wherein the particular sequential stream is a superblock of N blocks of data.

6. The method as recited in claim 5, further comprising the step of:
decreasing the capacity of the prefetch cache as each of the N blocks is utilized by the processor.

7. The method as recited in claim 1, wherein the varying step further comprises the step of:
varying the capacity of the prefetch cache as a function of a number of presently active sequential streams in the I/O request stream.

8. The method as recited in claim 7, wherein the capacity of the prefetch cache is increased when more prefetch packets are requested in the I/O request stream.

9. The method as recited in claim 8, wherein a capacity of the main cache is decreased as the capacity of the prefetch cache is increased.

10. The method as recited in claim 7, wherein each sequential stream is a superblock of N blocks of data.

11. The method as recited in claim 10, further comprising the step of:
decreasing the capacity of the prefetch cache as each of the N blocks is utilized by the processor.

12. A data processing system comprising:
a processor;
a main memory;
a cache memory partitioned into a prefetch cache and a main cache; and
a bus system coupling the processor to the main memory and the cache memory; and
circuitry for varying a capacity of the prefetch cache as a function of a magnitude of one or more sequential streams in an I/O request stream emanating from the processor.

13. The data processing system as recited in claim 12, wherein the varying circuitry further comprises:
circuitry for varying the capacity of the prefetch cache as a function of a run length of a particular sequential stream in the I/O request stream.

14. The data processing system as recited in claim 13, wherein the capacity of the prefetch cache is increased when longer prefetch packets are requested in the I/O request stream.

15. The data processing system as recited in claim 14, wherein a capacity of the main cache is decreased as the capacity of the prefetch cache is increased.

16. The data processing system as recited in claim 13, wherein the particular sequential stream is a superblock of N blocks of data.

17. The data processing system as recited in claim 16, further comprising:
circuitry for decreasing the capacity of the prefetch cache as each of the N blocks is utilized by the processor.

18. The data processing system as recited in claim 12, wherein the varying circuitry further comprises:
circuitry for varying the capacity of the prefetch cache as a function of a number of presently active sequential streams in the I/O request stream.

19. The data processing system as recited in claim 18, wherein the capacity of the prefetch cache is increased when more prefetch packets are requested in the I/O request stream.

20. The data processing system as recited in claim 19, wherein a capacity of the main cache is decreased as the capacity of the prefetch cache is increased.

21. The data processing system as recited in claim 18, wherein each sequential stream is a superblock of N blocks of data.

22. The data processing system as recited in claim 21, further comprising:
circuitry for decreasing the capacity of the prefetch cache as each of the N blocks is utilized by the processor.

23. The data processing system as recited in claim 12, wherein the prefetch cache is configured to store sequential requests in an input/output (I/O) request stream, and wherein the main cache is configured to store non-sequential requests in the I/O request stream.
